(19) United States
(12) Patent Application Publication
(10) Pub. No.: US 2021/0365029 A1
(43) Pub. Date: Nov. 25, 2021

(54) SAFETY SYSTEMS FOR SEMI-AUTONOMOUS DEVICES AND METHODS OF USING THE SAME

(71) Applicant: Avidbots Corporation, Kitchener (CA)

(72) Inventors: Pablo Roberto MOLINA CABRERA, Waterloo (CA); Ronald Scotte ZINN, Kitchener (CA); Kenneth LEE, Mississauga (CA); Jon MCAUSLAND, Kamloops (CA); Yoohee CHOI, Waterloo (CA); Dan ERUSALIMCHIK, Kitchener (CA)

(21) Appl. No.: 17/031,995

(22) PCT Filed: Mar. 27, 2019
(86) PCT No.: PCT/CA2019/050378

§ 371 Date: Sep. 25, 2020

Related U.S. Application Data
(60) Provisional application No. 62/648,571, filed on Mar. 27, 2018.

(51) Int. Cl. G05D 1/02; G05D 1/00; F16P 3/14; A47L 11/40; A47L 11/29

(52) U.S. Cl. CPC G05D 1/0214; G05D 1/0223; G05D 1/0088; G05D 1/0011; G05D 1/027; A47L 2201/04; A47L 11/4011; A47L 11/29; A47L 11/4061; G05D 2201/0203; F16P 3/142

(57) ABSTRACT

Systems and methods of monitoring the position of semi-autonomous or fully-autonomous devices for safe navigation in a dynamic, unstructured environment can include processes to detect localization errors via an odometry check, a laser map alignment check, or a bimodal distribution check; detect tracking errors to monitor and/or control device trajectory and/or to avoid device rollover; regulate velocity control based on static or dynamic safety zones for collision avoidance; perform system integrity checks to maintain desired performance over time; and/or the like. These processes may interface with and/or utilize sensors on the device and may provide inputs for a safety monitor system that oversees device safety. In addition, an onboard computer system with a real time operating system may be used to enable real time monitoring and response during device navigation and to execute relevant processes associated with this system independent of other processes performed.

### CROSS REFERENCE TO RELATED APPLICATIONS

The application claims priority to and the benefit of U.S. Provisional Patent Application Ser. No. 62/648,571, entitled “SAFETY SYSTEMS FOR SEMI-AUTONOMOUS DEVICES AND METHODS OF USING THE SAME”, filed on Mar. 27, 2018, the disclosure of which is incorporated herein by reference in its entirety.

### BACKGROUND

The embodiments described herein relate to semi-autonomous devices and more particularly, to safety systems and methods of using safety systems for semi-autonomous devices such as, for example, semi-autonomous cleaning devices and/or floor scrubbers.

Semi-autonomous devices and/or fully-autonomous devices, such as robots that clean a surface, mow a lawn, collect items from a stocked inventory, etc., use a set of motors, sensors, and on-board software to navigate from one location to another in an environment. Navigating from one location to another can include, for example, exploring a new environment, mapping and otherwise retaining in memory one or more characteristics of the environment, localization and/or locating where the device is within the environment, planning a trajectory to reach a desired location in the environment, and/or the like. Moreover, to successfully navigate through an environment, the device can detect and avoid obstacles, which can include walls, furniture, people, holes, cliffs, stairs, or other devices in the environment.

In some instances, navigation through or in static, structured environments, such as a flat, unoccupied warehouse, can be readily achievable as obstacles and/or boundaries within the environment may be more predictable. Dynamic, unstructured environments, such as an indoor mall or an outdoor park, on the other hand, can pose significant challenges to navigation. For example, the presence of unexpected obstacles can lead to collision(s), which may cause damage to the device or the obstacle. Additionally, changes to the environment can lead to localization errors due to inconsistencies between outdated environmental maps and/or data that the device uses to navigate and the current state of the environment. Moreover, in some known devices, systems and/or methods configured to safely navigate such devices through an environment fail to sufficiently process and/or monitor device localization and/or fail to detect obstacles in real time and with deterministic response times.

Accordingly, it is desirable to have systems and/or methods which enable and/or facilitate the safe navigation of a robot in a dynamic unstructured environment. In some instances, it is desirable for such systems and/or methods to function and/or to otherwise be performed in a deterministic fashion. In addition, it is desirable for such systems and/or methods to function and/or perform regardless of one or more faults, malfunctions, and/or operations of any other system, component, application, and/or function of the device.

### SUMMARY

Systems and methods for facilitating the safe navigation of semi-autonomous or fully-autonomous devices in dynamic, unstructured environments based at least in part one or more real time processes that monitor device localization and detect obstacles, exhibit deterministic response times, and execute regardless of errors with on-board software are described herein. In some embodiments, systems and methods of monitoring the position of semi-autonomous or fully-autonomous devices for safe navigation in a dynamic, unstructured environment can include, but are not limited to one or more processes to detect localization errors such as an odometry check, a laser map alignment check, or a bimodal distribution check, tracking errors to monitor and/or control device trajectory and/or to limit, prevent, or avoid device rollover especially due to erroneous input commands, regulating velocity control based on static or dynamic safety zones for collision avoidance, system integrity checks to maintain desired performance over time, and/or the like. These processes may interface with and/or utilize sensors on the device and may provide inputs for a safety monitor system that oversees device safety. In addition, an onboard computer system with a real time operating system (OS) may be used to enable real time monitoring and response during device navigation and to execute relevant processes associated with this system independent of other processes performed (e.g., in or on an application layer).

In some instances, the systems and/or methods described herein can result in a desired level of reliability and repeatability based at least in part on safety-specific nodes, functions, and/or processes running at specific and/or desired times and executing regardless of other processes running in the application layer. The systems and/or methods can also protect the device from any erroneous commands (e.g., from the application layer) that could otherwise result in a collision, tipping hazard, or unwanted movement of the robot by rejecting such commands, thereby limiting and/or substantially preventing a potential safety incident.

### BRIEF DESCRIPTION OF THE DRAWINGS

FIG. 1 is a system diagram illustrating one or more system processes used to monitor, regulate, and/or maintain the safety of a semi-autonomous or fully-autonomous device during navigation according to an embodiment.

FIG. 2 is a top view of a cleaning device illustrating one or more safety zones according to an embodiment.

FIG. 3 is a risk detection operational diagram illustrating various risks.

FIG. 4 is a risk actions diagram illustrating the various actions related to risk and risk management.

FIG. 5 is a block diagram illustrating an exemplary implementation of the safety management system.

FIG. 6 is a block diagram showing the interconnection of the functional modules used for visual streak detection by the floor scrubber.

FIG. 7 shows a system block diagram for a detection algorithm.

### DETAILED DESCRIPTION

In some embodiments, systems and methods of monitoring the position of semi-autonomous or fully-autonomous devices for safe navigation in a dynamic, unstructured environment can include, but are not limited to one or more processes to detect localization errors such as an odometry check, a laser map alignment check, or a bimodal distribution check, tracking errors to monitor and/or control device trajectory and/or to limit, prevent, or avoid device rollover especially due to erroneous input commands, regulating velocity control based on static or dynamic safety zones for collision avoidance, system integrity checks to maintain desired performance over time, and/or the like. These processes may interface with and/or utilize sensors on the device and may provide inputs for a safety monitor system that oversees device safety. In addition, an onboard computer system with a real time operating system (OS) may be used to enable real time monitoring and response during device navigation and to execute relevant processes associated with this system independent of other processes performed (e.g., in or on an application layer).

In some instances, the systems and/or methods described herein can result in a desired level of reliability and repeatability based at least in part on safety-specific nodes, functions, and/or processes running at specific and/or desired times and executing regardless of other processes running in the application layer. The systems and/or methods can also protect the device from any erroneous commands (e.g., from the application layer) that could otherwise result in a collision, tipping hazard, or unwanted movement of the robot by rejecting such commands, thereby limiting and/or substantially preventing a potential safety incident.

In some embodiments, a method for safely navigating a semi-autonomous or fully-autonomous device in an environment can include monitoring the functioning of a localization system; verifying that a motion controller is tracking a planned path within a desired tolerance; verifying an incoming velocity does not conflict with dynamic and/or inertial (tipping hazard) limits of the device; limiting device velocity based on safety zones to prevent collisions during device traversal including both obstacles and negative obstacles such as “cliffs,” etc.; verifying accuracy of one or more sensors providing input into the device by modelling expected input(s) and comparing different sources; and verifying that commanded input/output (I/O) and velocity commands are responding as desired. To provide additional redundancy and safety, additional detectors such as proximity detectors or contact detectors can be incorporated on the autonomous device. Contact or close unexpected proximity to an object would preferably initiate an expedient safety stop or shutdown. In some embodiments, such a method for safely navigating the device in an environment can be executed on the same computer system as the device application or can be executed on a separate computer system in communication with the computer system of the device. Such computer systems can implement a device navigation system that is capable of controlling the movements of the device.

The systems and/or methods described herein can be used on any suitable device, machine, system, robot, etc. For example, in some embodiments, the systems and methods described herein can be used with and/or on a semi-autonomous cleaning robot or the like. In some embodiments, such a semi-autonomous cleaning robot can be similar to or substantially the same as any of those described in U.S. Patent Publication No. 2016/0309973 entitled, “Apparatus and Methods for Semi-Autonomous Cleaning of Surfaces,” filed Apr. 25, 2016 (referred to herein as the “'973 publication”), the disclosure of which is incorporated herein by reference in its entirety.

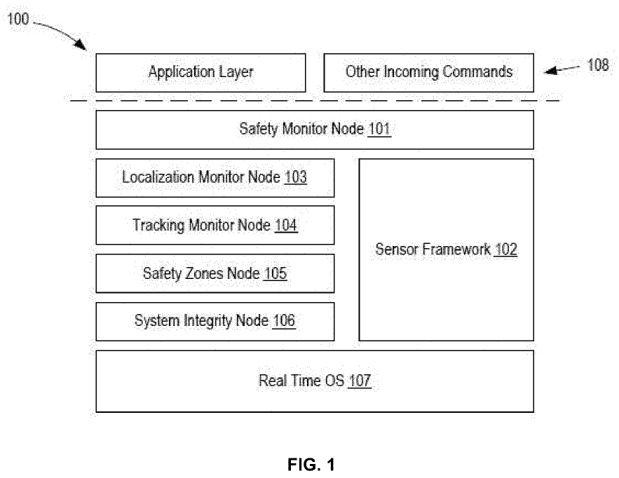

FIG. 1 illustrates an overview of a system 100 configured to monitor the position of a device such as a semi-autonomous or fully-autonomous cleaning robot, for safe navigation in a dynamic, unstructured environment. The system 100 can be and/or can include, for example, one or more system components, architectures, devices, modules, engines, processors, etc. configured to perform and/or execute one or more processes, procedures, functions, code, etc. store, for example, in a memory or the like. In some embodiments, the system 100 can be included in and/or performed by an electronic or compute device. Such an electronic or compute device can be, for example, included in an electronic system of the cleaning device or robot (e.g., the electronic system of the devices described in the '973 publication).

In some embodiments, the electronic and/or compute device can include at least a memory and a processor. The memory can be, for example, a random access memory (RAM), a memory buffer, a hard drive, a read-only memory (ROM), an erasable programmable read-only memory (EPROM), and/or the like. The processor can be any suitable processing device configured to run or execute a set of instructions or code (e.g., stored in the memory). For example, the processor can be a general purpose processor (GPP), a central processing unit (CPU), an accelerated processing unit (APU), and application specific integrated circuit (ASIC), a field programmable gate array (FPGA), and/or the like. In some embodiments, the electronic and/or compute device can include and/or can be configured to execute one or more modules, systems, architectures, engines, nodes, etc. Accordingly, the system 100 shown in FIG. 1 can be and/or can be executed by an suitable architecture including one or more operatively-coupled electrical components that can include, for example, a memory, a processor, electrical traces, optical connectors, software (executing in hardware), and/or the like. For example, the system 100 can be and/or can include any combination of hardware-based architecture(s), module(s), engine(s), node(s), etc. and/or software-based architecture(s), module(s), engine(s), node(s), etc. capable of performing one or more functions associated with the safe operation of the semi-autonomous or fully-autonomous device.

The safety monitor system is the central system that takes the input velocity and the monitor status from all the monitors described above and sends the final velocity to the hardware systems. It is responsible for commanding the robot to come to a stop or triggering the emergency stop depending on the severity of the failures. Given that system 100 may be unstable during the initialization phase and when in emergency stop state, the reported status from all the monitors are ignored in those states. During the normal operation state, any failures reported will bring the robot to a complete stop and stay in the error state until the failure is cleared and a user acknowledges the failure occurrence. During times when there is a greater degree of localization uncertainty, the device may be directed by the safety monitor system to move more slowly to compensate for the higher likelihood of encountering an unexpected obstacle. Localization uncertainty is also present in dynamic environments, where moving or unexpected objects are detected. In some embodiments, infrared cameras or sonar ranging systems may also be used to enhance the detection of environmental hazards due to moving or unexpected objects.

A Safety Monitor Node 101 oversees the system and regulates device velocity according to inputs from various monitors and sensors. A Sensor Framework 102 manages operation of all device sensors. In parallel to the Sensor Framework 102, a Localization Monitor Node 103, a Tracking Monitor Node 104, a Safety Zones Node 105, and a System Integrity Node 106, monitor device localization, device trajectory, environmental obstacles, and sensor integrity, respectively. A Real Time OS 107 manages execution of all processes and ensures deterministic response times. Additionally, the safety system is separated from the application layer and other incoming commands 108 to avoid possible interference with the processes overseen by the Safety Monitor Node 101.

In some embodiments, the Safety Monitor System Node 101 monitors and regulates device velocity in a continuous loop. The Safety Monitor System Node 101 may include one or more inputs such as a commanded input velocity and inputs from the Localization Monitor Node 103, Tracking Monitor Node 104, Safety Zones Node 105, and System Integrity Node 106. If no errors or collision warnings are determined and/or otherwise present in the device during a particular cycle, the device will send the commanded input velocity to the appropriate hardware systems to execute; otherwise, if any error or collision warning occurs, the Safety Monitor System Node 101 will regulate the device velocity accordingly to maintain device safety.

In some embodiments, the system 100 may include a Localization Monitor Node 103 that continuously monitors the localization status of the device based on inputs from one or more localization check processes. The localization check processes may include an odometry check, laser map alignment check, or bimodal distribution check. If one or more localization check processes detects an error, the Localization Monitor Node 103 can send a localization safety warning (e.g., a signal) to the Safety Monitor Node 101. The Safety Monitor Node 101 can then execute a set of actions to stop the device and notify a remote monitoring operator of a device error. In some embodiments, the initial position of the cleaning device can be set by placing it in a known start position, operator entry of a known initial position, or calculating a known start position by measuring position relative to known position markers.

In some embodiments, the system 100 and/or device may include and/or may perform an odometry check that evaluates device localization by comparing the location of the device based on odometry data received from one or more encoders (e.g., sensors or the like included in the Sensor Framework 102) corresponding to at least one wheel motor in the device and a computed location based on a localization algorithm (e.g., a location calculated and/or determined by the Localization Monitor Node 103). Generally, errors in odometry data over a relatively short period of time are negligible; therefore, the difference between the reported device location based on the odometry data and a computed device location should be small. In these embodiments, the odometry check may perform a localization check by evaluating the difference between the translation of a device computed using odometry data and the device location at a time t and time t+1, and the translation of the device computed from a localization algorithm. A similar localization check can be performed for the heading of the device. If the difference for either the translation or heading exceeds a specified tolerance, the odometry check will trigger a localization lost warning (e.g., signal), which will be sent to and/or determined by the Localization Monitor Node 103.

In some instances, the odometry check may yield and/or result in erroneous readings from the encoders. Possible causes for erroneous readings may include a failing encoder, wheel slippage, or a stuck wheel. When large errors are present in the odometry data for at least one of the wheels in the device, the localization algorithm may produce an erroneous device location or heading. In such instances, the odometry check described above may not detect these errors because the location computed via the localization algorithm may be based at least in part on the incorrect odometry data. As described above, however, the device may include and/or may perform a laser map alignment check that can be used as a failsafe, backup, supplemental, and/or other means for determining device location. For example, the laser map alignment check can include evaluating the device localization by comparing one or more distances measured between the device and a feature in the environment using a laser scan and one or more corresponding distances computed based on the device location and a stored map of the environment (e.g., stored in the memory of the device and/or otherwise accessible to the device). In some instances, the laser map alignment check may use a precomputed distance field to determine the one or more distances between the device and the feature of or in the environment measured by a laser scan. The distance field includes and/or represents a grid with the same dimension and resolution as the stored map of the environment. In this distance field, a closest occupied pixel can be designated and/or associated with a coordinate (e.g., in at least one plane, at least two planes, or at least three planes) that most closely matches the location or coordinate of the device in the stored map at the time the laser map alignment check process is executed. Accordingly, each pixel in the distance field stores a Euclidean distance from that particular pixel to the closest occupied pixel. For example, the closest occupied pixel can be assigned a distance value of zero in the distance field and neighboring empty pixels (e.g., unoccupied pixels adjacent to the closest occupied pixel) can be assigned a distance equal to the resolution of the distance field and map.

In some embodiments, the distance field is precomputed once and used throughout the lifetime of the algorithm. To check the alignment of a laser scan to the stored map (or stored map data), endpoints of the laser scan's beam can be projected onto the map coordinates based on the device's location in the map. For each laser beam endpoint, the distance field can be used to compute the distance of that single beam to the closest occupied cell. Beams associated with a distance relative to the map below a certain threshold can be considered aligned, while beams above the threshold can be considered misaligned. As such, a ratio of aligned beams can be used as a measure of the alignment of the laser relative to the map.

In some instances, an alignment score can be computed to assess how well the laser scan aligns with the stored map. In some instances, the alignment score may be computed as a ratio of the aligned beams divided by the total number of beams, where a relatively high alignment score indicates the laser scan is sufficiently aligned to the stored map. However, if the alignment score exhibits a significant reduction within a set time window, the laser map alignment check process can trigger a localization lost warning (e.g., signal), which can be sent to and/or determined by the Localization Monitor Node 103. For example, a heading error may cause the laser scan to be rotated relative to the stored map. In other instances, alternative alignment scores may be computed from the array of beam distances. For example, statistical parameters including, but not limited to the median or average of the array of beam distances may also be used to assess device localization.

In some embodiments, the system 100 and/or device may include and/or perform a bimodal distribution check that evaluates an impending loss of localization based on the presence of new obstacles. For example, in indoor environments that contain a modified environment, for example, a new wall that was not present at some prior time, XY coordinates for navigation may not be able to determine and/or discern the device location relative to the modified environment. In this example, a particle distribution can be visualized in two-dimensional space (2D) using the XY coordinate plane of the environment. The presence of symmetric or antisymmetric pairs of features may manifest, for example, as two peaks, or a bimodal distribution, in the 2D visualization of the particle distribution. The bimodal distribution check can thus, evaluate an impending loss of localization based on the observation of at least two peaks, or a secondary mode of attraction, in a sampled particle distribution wherein the particles represent possible device poses, or positions and orientations, within the environment. In some embodiments, the bimodal distribution check can begin and/or can be initialized with an initial random sampling of the particle distribution. Using a combination of this initial distribution and a physical model for device motion, which may use device sensor readings as input, the particle distribution can be resampled. This process can be iterated to determine and/or define a particle distribution that becomes progressively become localized to the device location.

In some embodiments, the system 100 and/or device may include a detector, whether hardware, software, or a combination thereof, which can identify at least two peaks in a particle distribution and is insensitive to the number of particles or physical size of the distribution. The detector can be used to alert an operator or system of new obstacles in the environment, such as a wall that was not previously present in the environment, and enable the device to perform corrective action. In some embodiments, the detection of a bimodal distribution may be achieved by computing the density of particles projected along one or more axes, thereby reducing a general two-dimensional determination to a one-dimensional determination. Along one axis, a histogram may be computed wherein each element contains the number of particles at a position along the axis. In instances where position is discretized along a variable i, the curvature or “peakness” may be defined as:

c(i)=−h(i−1)+2*h(i)−h(i+1) (1)

where c(i) is the curvature at i and h(i) is the number of particles at i.

Generally, a calculated score or value of indicates strong peaks which have high curvature values. A normalized bimodal score may be used to quantify the likelihood that a bimodal distribution is present within the particle distribution. The normalized bimodal score may be computed following normalization of the histogram data by the number of entries and the identification of two plausible peaks. The normalized bimodal score may be computed using:

s=4*c(i)*c(j)*d(i,j) (2)

where i and j are the location of the two peaks and d(i,j) is an envelope in [0,1] expressing the distance between peaks i and j.

The envelope function d(i,j) may be expressed using any convenient chopping function such as the logistic function. Furthermore, the normalized bimodal score can indicate that two peaks that are sufficiently close may be rejected since they represent a condition where both peaks may belong to the same mode. Additionally, the bimodal score may be constructed to be invariant with respect to at least one of the number of particles and the physical diameter of the distribution. As an example, s=0 indicates the presences of a single peak, which is desirable for a well-localized device. In contrast, s=1 indicates the presence of two very strong and distinct peaks well separated by distance and with few particles outside either peak. In present embodiments, a score “s” greater than 0.25 provides a reasonable threshold that corresponds to fairly clear bimodal distributions and the impending loss of localization.

In some instances, the choice of which axis along which to calculate the particle density can be arbitrary and based on user input. In some instances, a “radial” projection may be used wherein an anchor point is chosen, for example the center point of a concentration of particles, and the axis represents the distance between each particle and the anchor. In other instances, an axis may be chosen based on known features of the device motion, which may improve detector performance such as greater sensitivity (e.g., fewer false negative detection events, or greater specificity, fewer false positive detection events). For example, a “birdwing” detector may be used where the axis is chosen to be orthogonal to the device motion, which can capture events where the device's trajectory swings within a predetermined distance of a boundary of the environment. In yet more embodiments, two or more axes may be used for projection. For example, two axes may be chosen based on a cardinal XY coordinate system. In another example, major and minor axes may be chosen based on a principal component analysis where the major axis represents the longest distance across a particle distribution and the minor axis represents the shortest distance across a particle distribution. This particular implementation may result in relatively low noise characteristics and may be compatible with elongated distributions oriented along an arbitrary axis.

In some embodiments, the system 100 and/or device may include a Tracking Monitor Node 104 including and/or performing one or more processes configured to compare positional and body heading tracking error measurements, which are defined as the difference between the best current localization estimate and the current desired trajectory position and body orientation, with dynamic tracking error tolerances (localization check mechanism). Dynamic tracking error tolerances are dependent, at least in part, on trajectory curvature wherein curves have slightly relaxed tolerances to accommodate slightly increased tracking and localization errors that are present during turns. If one or both of the tracking errors exceeds their respective dynamic threshold, the Tracking Monitor Node 104 may send a tracking failure alert (e.g., signal) to a human-in-the-loop safety notification system and command software interface, as well as logging the tracking failure in memory. In these embodiments, a tracking failure alert of this type can be cleared by a human operator who, in this instance, may need to perform one or more device recalibrations that include, but are not limited to re-planning, repositioning, or re-estimation of localization. Accordingly, the Tracking Monitor Node 104 may monitor tracking error measurements and execute one or more processes continuously in a loop at substantially the same frequency as the control loop to ensure timely and safe commands are sent to the motors and/or other portions of the device. Generally, in instances where tracking error measurements are large, tracking failures (e.g., at least one of a trajectory planning error, a significant wheel slip due to floor type changes or a collision event, a mechanical or electrical failure in the drive system that deteriorates tracking performance over time, significant localization errors, and/or the like) are typically the cause. Thus, the Tracking Monitor Node 104 can be another system to detect localization errors.

In some embodiments, the Tracking Monitor Node 104 may include a tipping safety process that checks the operating envelope of the device to reduce or substantially prevent the occurrence of oversteering conditions, which may lead to device rollover. Generally, the maximum allowable steering angle decreases as a function of the input command velocity. In instances where the input command velocity exceeds the maximum absolute steering angle, the input command velocity and/or absolute steering angle is reduced until a stable point is reached in the operating regime defined in a steering angle vs. velocity function. In these embodiments, imposing saturation limits to the device steering rate and/or angle and velocity reduces the risk of the device tipping while performing high-speed turns. In some instances, executing high-speed turns enables greater device performance. For example, when the device is a cleaning robot, execution of high-speed turns can reduce the overall time required for cleaning and can improve the quality of cleaning. Accordingly, the Tracking Monitor Node 104 can check command saturation continuously in a loop that may operate at the same frequency as the control loop to achieve the desired stability of input commands prior to being sent to the steering motors and drive motors. In some embodiments, the operating envelope may be determined experimentally under a worst-case configuration based on the device mass, wheel type, floor type, and with an additional configurable safety factor. An inertial momentum unit (IMU) sensor or the like can also be used to detect tipping problems, issues, and/or events.

In another embodiment, the Tracking Monitor Node 104 may also include a feature to smooth input commands to reduce the likelihood of sudden, unpredictable, jerky device motions and input commands while also saturating input commands as needed before being sent to steering motors and drive motors. In many instances, smoothing the input command may provide a velocity profile that is visually more natural and safe in appearance and execution, may provide increased and/or desired performance (e.g., increased cleaning in an embodiment where the device is a cleaning robot), and may reduce stress in device components such as the frame, motors, wiring, and electronics, which could otherwise lead to premature and unexpected failures creating more safety concerns.

In some embodiments, the system 100 and/or device may include a Safety Zones Node 105 that detects obstacles in close proximity to the device based on a predefined safety zone, or region around the device, and regulates device motion accordingly to avoid collision. The Safety Zones Node 105 can continuously monitor and/or process data from on-board sensors (e.g., included in the Sensor Framework 102) to detect obstacles that may collide with the device based on the device's current commanded velocity. If an obstacle is detected within the safety zone, the Safety Zones Node 105 can send a command (e.g., signal or instruction) to stop the device by reducing velocity to zero. Furthermore, the Safety Zones Node 105 process can detect both positive obstacles, such as walls, furniture, people, other devices, stair risers, etc. and negative obstacles, such as holes, cliffs, stair treads, etc. In some instances, detection of negative obstacles can be based on post processing of sensor data performed in or by the Sensor Framework Node 102.

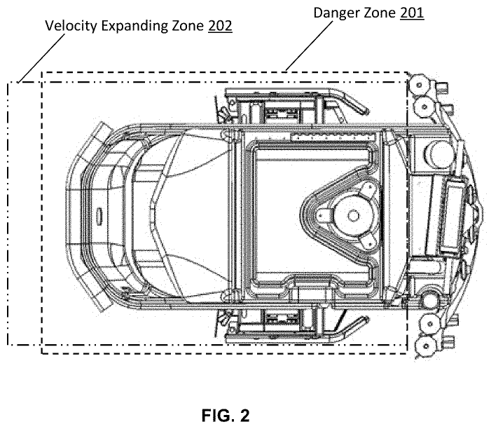

The Safety Zones Node 105 can detect obstacles using one or more predefined safety zones around the device based on the operating conditions of the device. In some embodiments, two safety zones, which are named the Danger Zone 201 and Velocity Expanding Zone 202 in FIG. 2, can be used to dynamically adjust the safety zone based on the motion of the device. The Danger Zone 201 is a static safety zone that ensures obstacles in close proximity to the device are detected independent of the device velocity and orientation. In some embodiments, the Danger Zone 201 can be based on and/or associated with the device footprint with or without a buffer added to the front, rear, sides, top, and bottom of the device to slightly enlarge the overall safety zone. According to another embodiment, the Danger Zone 201 may approximate the device footprint as a vectorized convex polygon with three or more line segments. Based on a top down view of the device, the polygon may be vectorized in either a clockwise or a counterclockwise direction. In contrast, the Velocity Expanding Zone 202 dynamically adjusts in size and rotates and/or shifts according to the velocity and orientation of the device in order to compensate for the increased stopping distance for a device in motion needed to avoid obstacles. The Velocity Expanding Zone 202 can be first expanded longitudinally along a straight line heading to compensate for the device stopping distance, which can be approximated using the commanded device velocity and the maximum acceleration or deceleration supported by the device. The Velocity Expanding Zone 202 may then be rotated by a scaled down angular velocity to avoid exaggerated rotational motion.

In some embodiments, one or more sensors, such as a laser, may be used to perform a point scan around the device to detect obstacles within the safety zone. For example, a laser may be rotated 360 degrees around the device in a clockwise (or counterclockwise) manner and during rotation, data points, representing the distance between obstacles or environmental boundaries and the device, are taken at constant increments. Methods developed to assess whether a point is located inside or outside a polygon, such as the winding method, can be used to detect if an obstacle, represented as one or more points, is located within the safety zone. Additionally, such methods can further identify the line segment in a polygon that is closest in space to a data point within the safety zone. By taking the cross product of the vector representing the polygon line segment and a vector that intersects an obstacle data point while oriented orthogonal to the plane of motion, the resultant vector will provide the direction of the obstacle relative to the device.

In some embodiments, the system 100 and/or device may include a System Integrity Node 106 that includes and/or that executes one or more processes to monitor sensor performance and data rates to ensure the sensors are functioning properly. If sensors malfunction or provide inconsistent data rates, device navigation may be affected creating a potential safety hazard. Sensors monitored by the System Integrity Node 106 may include, but are not limited to lasers, 2D sensors, 3D sensors, encoders, and/or any other suitable sensor (e.g., such as those included in the Sensor Framework 102). If at least one sensor fails to meet expected performance metrics or data rates, the System Integrity Node 106 can send a command (e.g., signal or instruction) to stop the device by reducing velocity to zero and await human operator intervention before resuming.

One of the functions of the System Integrity Node 106, as described above, is to monitor sensor data rates and, in at least some embodiments, detect whether sensor data rates are slower than expected or dropped entirely. Sensor data rates may be susceptible to inconsistencies if computed for sequential sets of data taken at each system cycle due to fluctuations in hardware performance, variability in read and write speeds for data storage, and bottlenecks arising from competing data streams. These inconsistencies can be amplified for high rate sensors. During device operation, data rate inconsistencies may lead to erroneous estimates of device location or obstacle location based sensor data resulting in false positive localization errors and obstacle detection. Thus, in some embodiments, the System Integrity Node 106 can perform one or more processes configured to reduce the occurrence of false positive errors originating from data rate inconsistencies by calculating a rolling average of the sensor data rate across multiple system cycles, thus averaging over variations that may occur on a per cycle basis. This averaged sensor data rate can then be compared with an expected data rate. Additionally, the System Integrity Node 106 can detect when a sensor stops operating by using an independent background timer that periodically checks the current frequency at a slower rate than the sensor data rate. If the System Integrity Node 106 does not receive a sensor data callback (e.g., response signal or the like) within a predetermined period during the background timer, the System Integrity Node 106 can trigger an error. If the sensor is operating properly, each sensor data callback will reset the timer, delaying an error from triggering and thus ensuring the background timer does not interfere with device operation.

One of the functions of the System Integrity Node 106, as described above, is to monitor sensor performance and, in at least in one embodiment, detect faulty behavior or malfunctions in the sensors. In some instances, the lasers in laser scanning systems may be configured incorrectly during production leading to variability in the field of view. Lasers incorrectly configured with a field of view narrower than a desired field of view can exhibit limited vision, which can render the laser scanning system unable to properly detect obstacles or perform localization. Accordingly, the System Integrity Node 106 can detect incorrectly configured lasers by checking the number of data points in a single scan and the resulting field of view from the scan. In other instances, encoders, which can accompany each motor driven wheel, are used to measure the rotational change of a wheel, which enables readings of linear and angular velocity of the device during operation. The odometry data can be collected using a rolling average to reduce variabilities in sensor readings as described above. However, faulty encoders may result in erroneous velocity readings that can disrupt device motion. In some embodiments, there may be a single front wheel encoder and two rear wheel encoders corresponding to each motor. The System Integrity Node 106 can detect encoder failure for a particular wheel by comparing the reported linear and angular velocity of the device, which is computed from the number of encoder ticks over a known period of time, and an expected linear and angular velocity based on an input command velocity. For clarification, in some embodiments, the input command velocity is applied using a software controller, which converts the velocity to revolutions per minute (RPM) before sending the command directly to the hardware motor controller resulting in a delay between initial command and hardware execution. This delay and hardware acceleration and deceleration limits are taken into consideration when estimating the expected velocity for a given input command velocity. If the difference between the reported device velocity and expected velocity exceeds a predetermined tolerance, the System Integrity Node 106 can report an encoder failure. Additionally, odometry data from each wheel of a device can be compared, with a difference in the odometry data exceeding a predetermined threshold being indicative of a wheel encoder failing.

If data from a particular source reaches a certain range or is of certain characteristics, the data from another source may be treated in a way different from how it would be treated under other conditions. For example, the weighting given to odometry measurements may be reduced if water is detected on the driving surface, since the water may lead to slippage, or if another sensor detects a surface of a different type. This water detection may also reduce the maximum safe driving speed or turning angle. In another example, the continued presence of new and unplanned obstacles may indicate a more populated area than expected, leading to a reduced certainty weighting for all location measurements, which may lead to a lower and more cautious driving speed which is sustained even in a subsequent instantaneous absence of obstacles. The lower the certainty of location or presence of obstacles, the more cautious the vehicle should be, in particular as relates to speed.

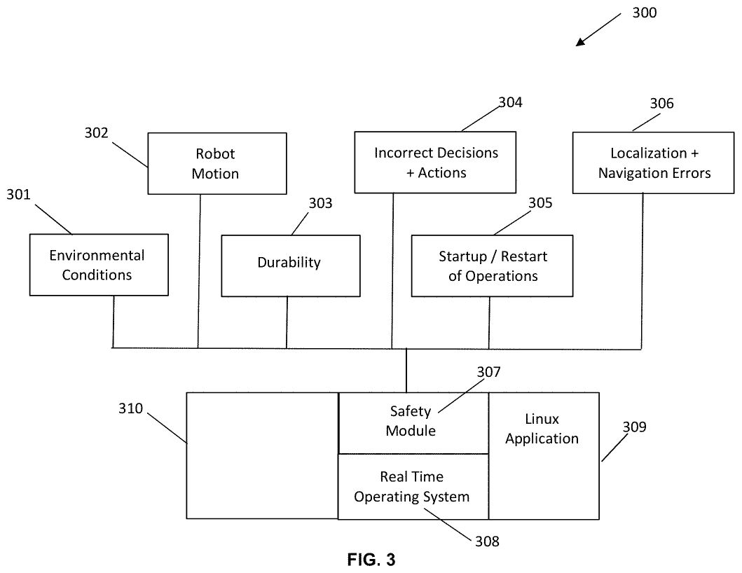

FIG. 3 is a risk detection operational diagram illustrating the risk detection sources and the interconnection with the risk management system for the autonomous floor cleaner. Risk management system 300 may also incorporate components, systems and subsystems as shown in FIG. 3.

The Environmental Conditions sensory system 301 consists of Odometry which is often implemented as a rotary encoder on the wheels of the autonomous floor cleaner. In addition, wheels that are capable of steering the robot may also have encoders or other sensors that give an indication of whether the autonomous floor cleaner is turning, and at what angle. The Environmental Conditions sensory system 301 also includes a tip detector function. In some embodiments, the tip detector is a sensor such as a accelerometer, that indicates when there are forces on the autonomous floor cleaner that would put it in danger of tipping, for example during a high speed turn. Environmental Conditions sensory system 301 also incorporates slip detection. This system compares the expected values of the odometry for each wheel with an expected value for the current velocity and heading of the autonomous floor cleaner. The Environmental Conditions sensory system 301 also preferably contains a computational element that adjusts a monitoring zone (expanding velocity zone) for visual and laser monitoring of obstacles and negative obstacles. For example, a fast moving autonomous floor cleaner will require a greater stopping distance, and thus will adjust the monitoring zone to monitor farther away from the autonomous floor cleaner in the direction of travel. Similarly, an autonomous floor cleaner that is turning will adjust the monitoring zone to monitor more in the direction of turn. Similarly, but not shown, other environmental sensors such as temperature, humidity, rain, and roughness of cleaning surface can be detected by appropriate sensors. When such conditions exceed the safe or recommended operating conditions for the autonomous floor cleaner, corrective action can be taken, such as halting the robot, or signalling an operator.

The Robot Motion sensory system 302 includes a monitoring system for determining the reliable operation of the wheel encoder system. The encoders on the wheels of the autonomous floor cleaner are monitored for consistent data flow with each other, and also with expected position results. The expected position results can be generated from a number of different sources, including a fixed map of the location that is being cleaned, laser distance measurement of obstacles in the environment, GPS location devices, radio frequency location markers or beacons, or triangulation systems. For example, one common failure mode for an optical encoder module is to begin missing pulses if the optical sensing element becomes worn or dirty. If the autonomous floor cleaner is heading in a straight direction, all encoders would be expected to advance equally per unit time. Thus, early failures and partial failures in sensing elements such as encoders can be detected. Additionally, another common mode of failure in sensing systems is blockage of process messages or freezing of the sensor reading from a sensor subroutine. This type of failure can occur through many types of software failure, such as stack overflows, process scheduling delays, rounding errors, or ring buffer coding problems. A preferred method to confirm the correct operation of the encoder systems, is to provide a heartbeat monitor process that takes independent periodic readings of the sensors and compares the results to fault conditions, for example not incrementing the encoder value when the autonomous floor cleaner is moving.

The Robot Motion sensory system 302 also includes functions to set limits on potentially dangerous combinations of input commands. One of the dangers for an autonomous floor cleaner is the potential for tipping, particularly when cleaning a sloped area, or attempting a high speed turn. Sensors such as gravitational sensors, magnetic sensors, inertial movement (IMU) and accelerometers can be combined in known ways to calculate tilt angle and velocity of the autonomous floor cleaner. These calculations can be further used to calculate a safe turn radius in both left and right directions for the current operating conditions of the autonomous floor cleaner. In addition, other physical attributes of the autonomous floor cleaner can be used to calculate the particular physics (mechanical model) that would impact a safe turn, including friction, inertia and moment. A dynamic modelling system is used to model the motion, friction, moment and inertia of the robot and the maximum inertia of the target robot in order to prevent tilting past a roll-over safe threshold if the commanded velocity changes too suddenly. For example, the cleaning fluid levels in various holding tanks on the autonomous floor cleaner could be taken into account to further refine the calculation of the safe turn radii.

Another hazard that impacts the stability of autonomous floor cleaners is the attempted execution of sudden or jerky changes to operating parameters. For example, such movements include quick starts, stops, sharp turns, or abrupt changes in other operating parameters. Such changes are difficult to model and predict, and often cause additional errors as a result of second order mechanical interface functions such as slipping and skidding. A preferred method to avoid such problems is to provide a mechanism where input commands are smoothed, so as to be gradually implemented by the autonomous floor cleaner over time. For example, a steering change command to change direction by 20 degrees, would be slowly implemented over several seconds as increasing the direction change incrementally to a final direction change of 20 degrees.

The Durability System 303 implements a safety monitoring function to monitor system integrity. One of the particular dangers of autonomous floor cleaner systems is that they are operating without close monitoring by persons for extended periods of time. This makes hazards such as combustion, electrical shock, overheating and sub-component failure more difficult to detect. A preferred solution is to provide an electrical monitoring system to multiple electrical components throughout the system by monitoring a current sensor to multiple components. For example, current and voltage sensors for motors, batteries, solenoids, actuators, and the like are monitored during operation to being within the range of typical operation. If the electrical sensing is out of range, an alert condition is created, and appropriate actions are taken. In some cases, this action may include disconnecting power from one or more subsystems, storing a record of the alert condition in memory, alerting a local or remote operator, or activating a fire suppression system. Additionally, the Durability System 303 implements an additional failure detection system to monitor the physical integrity of the autonomous floor cleaner. Many parts of an autonomous floor cleaner are installed manually, and are subject to vibrations and stress during normal operations. As such, it is not uncommon for portions of the autonomous floor cleaner to be partially or fully dislodged from their normal positions. A camera subsystem monitors the position of components such as squeegees, idler wheels, cowling pieces and the like, and compares the visual images to a reference stored image by matching the models of the components in the reference stored image to the models of the components in the camera subsystem image. Thus, parts that are missing or out of place can be detected, and appropriate alerts can be generated. The alert or can be an audible sound or beep, a vibration, an email, a text message and a notification on an operator control panel.

The Incorrect Decisions and Actions module 304 incorporates signals from encoders on the wheels of the autonomous floor cleaner. The encoders are monitored and the expected changes in position are tracked. The expected position results can be compared to data from a number of different sources, including a fixed map of the location that is being cleaned, laser distance measurement of obstacles in the environment, GPS location devices, location markers, visual or infrared camera systems, LIDAR or triangulation systems. The expected positional information generated by the wheel encoders will generate an expected distance to each of the known features in the environment. These distances can be compared to the measurements given by various sensor systems, for example compared with the measurements from a scanning laser distance measurement system. If the measurements match, and the error is small, the confidence in the location of the autonomous floor cleaner is high. The system can be used to establish a location on a map, by initializing several hypothetical locations on the map, then allowing the distance mapping algorithm to continuously run until one of the algorithms establishes a high confidence threshold for established position. In addition, because there is the possibility of more than one hypothetical location establishing a peak for location confidence, a calculation to prune multiple peaks is also implemented.

The Startup and Restart of Operation module 305 provides a method to control the autonomous floor cleaner during Startup and Restart operations. In particular, the autonomous floor cleaner starts in a ‘safe’ mode of operation, where speed is reduced and potentially dangerous functions are disabled during the process of establishing high confidence in the autonomous floor cleaner's location. In some implementations, operator input is required to confirm that the conditions are safe for autonomous floor cleaner start up, either through an operator control panel, a key, or another enabling mechanism. In some implementations, the operator input to start/restart can also be made by a remote operator. This allows minor warning or alert conditions to be overridden when an operator or a remote operator can confirm that the autonomous floor cleaner is safe to proceed.

The Localization and Navigation Errors module 306, notes differences between the sensor-measured values from the autonomous floor cleaner's measurement systems, such as a laser distance measuring system and the expected position of the autonomous floor cleaner. Small errors in navigation can be continuously corrected so that the accuracy of the position of the autonomous floor cleaner is improved. Similarly, discrepancies between the commanded speed or direction and the actual speed or direction in the environment can be corrected.

The Safety Module 307 processes the inputs from the physical sensors and modules and provides the logic for fast, reliable processing of events and signals. Modern computer systems often have unpredictable delays in processing events. Systems such as an autonomous floor cleaner require the safety systems to be responsive in predictable times. Isolating the safety module to a real time section of the processing board allows for detection and action in bounded times. The safety module 307 runs on top of the RTOS (Real Time Operating System) 308. The Linux Application 309 preferably runs other components of the autonomous floor cleaner software that are not as time critical.

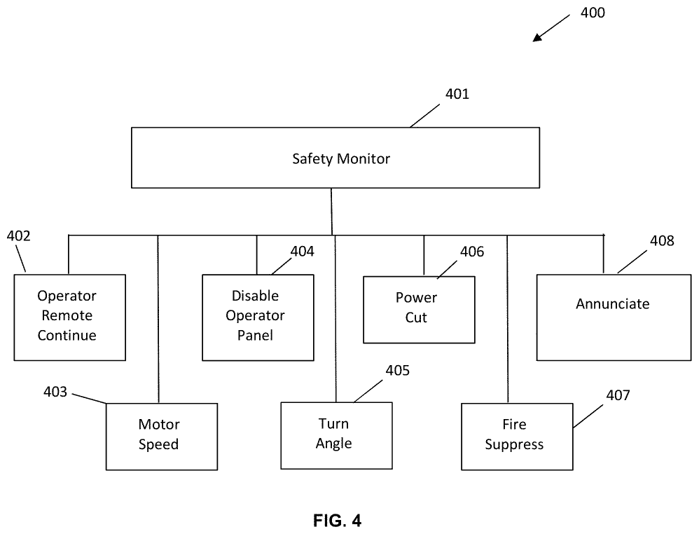

FIG. 4 illustrates a diagram of the actions that can be taken by the risk management system, and their interconnections to elements on the autonomous floor cleaner. The Safety Controls System 400 is comprised of the Safety Monitor 401 and one or more output elements 402-408, each of which elements may be routines implemented within the Safety Monitor 401, routines implemented in another system, separate systems or hardware components.

When the Safety Monitor 401 determines that a condition has arisen which may require a safety-related action to be taken, the Safety Monitor 401 activates one or more appropriate elements. The activation of the element may be through an internal procedure or function call, the sending of a signal to the element, the triggering of an interrupt connected with the element, the passing of data through a bus or other connection, or any other way of indicating to the element that action should be taken. The activation of any of these elements may cause an appropriate message to be written to an internal or remote log.

The Operator Remote Continue element 402 may be activated when the Safety Monitor 401 detects a condition which may be overridden by a remote operator. The Operator Remote Continue element 402 may cause the cleaner to slow or stop, and sends a message to the remote operator of the cleaner informing the remote operator that a warning condition has arisen. The remote operator must clear the condition by taking an action or sending a message to the cleaner. When this message is received by the cleaner, the cleaner resumes normal operation. In one implementation, the cleaner subsequently ignores the condition if it arises again within a certain time period. In one implementation, the Operator Remote Continue element 402 may set a timer which may only be cleared by receiving a message from the remote operator, and which timer may cause the cleaner to halt operation when it elapses. The Motor Speed element 403 causes the speed of the cleaner's drive motor or motors to be reduced or entirely halted.

The Disable Operator Panel element 404 causes the operator panel on the cleaner to become partially or entirely inoperative. This action may be taken if the Safety Monitor 401 detects the possibility of an unauthorized person tampering with the cleaner. In one implementation, the operator panel may be entirely deactivated, with any panel screen displaying no message or a message indicating the deactivation, and no input being processed from the panel. In one implementation, the operator panel may be input deactivated, with any panel screen continuing to display information as normal, but no input being processed from the panel. In one implementation, the operator panel may be partially deactivated, with only certain input being processed from the panel. In one implementation, the Disable Operator Panel element 404 may set a timer before disabling the panel, and may re-enable the panel upon the expiry of the timer.

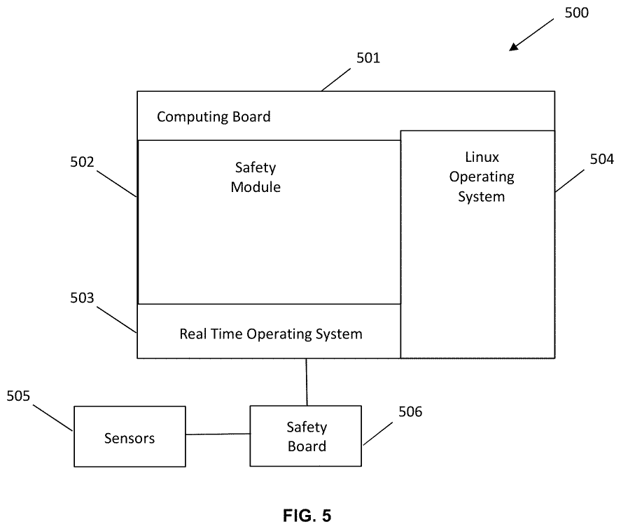

FIG. 5 is a block diagram illustrating a preferred exemplary implementation of the safety management system. Safety management system 500 consists of Computer Board 501, Safety Module 502, Linux Operating System 504 and Real Time Operating System 503. Computer Board 501 is connected to a separate Safety Board 506 which is also connected to a plurality of Sensors 505. The Sensors 505 provide measurement of the physical environment surrounding the autonomous floor cleaner and consist of cameras, laser measurement systems, LIDAR systems, proximity detection systems, current sensors, encoders, operator panel controls, remote command interfaces, and the like. The sensors directly couple to the Safety Board 506 that implements a variety of Safety Critical Functions (SCF's) that allow many of the safety functions to be fully independent of the proper execution of the software executing in other parts of the system. This allows functions like an operator initiated emergency stop, or a detection of a hazardous condition to cause a safer mode of operation independent of timing and logic in more complex functions of the autonomous floor cleaner. The Safety Board 506, is connected to the Safety Module 502 running on the Real Time Operating System 503. The Real Time Operating System provides an interface system that allows for execution of control functions in a predictable time. Thus, control loops that require execution in bounded time to ensure safety can be reliably executed. The Real Time Operating System 503 and the Safety Module both run on the hardware platform of the Computing Board 501. Also running on the Computing Board 501 is the Linux Operating System and Linux Applications (not shown). The Linux Operating System and Linux Applications provide the functions for control and operation of the autonomous floor cleaner that are less time critical than the bounded time control loops. The computing board can be implemented in a number of well-known architectures, including a single execution path microprocessor, a plurality of microprocessors with inter-process communication, Application Specific Integrated Circuits (ASICs), logic gates, or some combination of these.

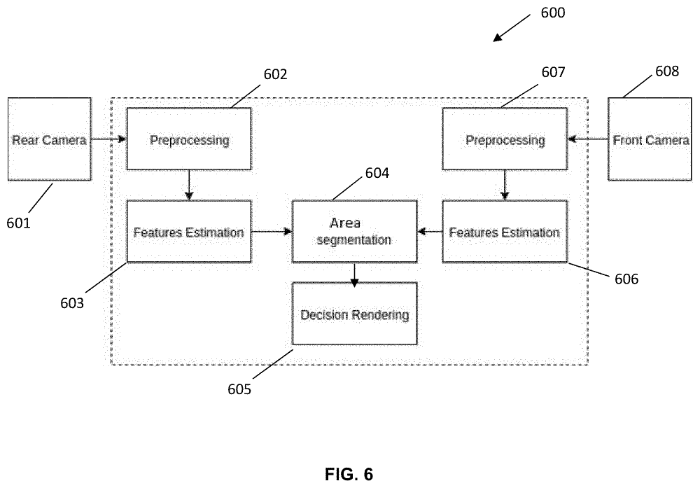

FIG. 6 is a block diagram showing the interconnection of the functional modules used by the floor scrubber. The block diagram 600 of FIG. 6 includes a Front Camera 608 that is mounted on the front of the floor scrubber, generally pointing in the direction of travel for the floor scrubber. The Front Camera 608 feeds the continuous image to the Preprocessing unit 607, which filters and transforms the image to a reference image. The Preprocessing Unit 607 applies image processing filters on the input image to remove noise, reduce size or transform to another space. These operations can be done with OpenCV or with other similar software libraries. The preprocessor outputs video data to the Features Estimation unit 606. The Features Estimation Unit 606 extracts edge, color and texture features from the preprocessed image. These operations could be done with OpenCV libraries or coded using algorithms found in well-known image processing literature.

Furthermore, system 600 also has a Rear Camera 601, that is mounted on the rear of the floor scrubber, generally pointing opposite the direction of travel for the floor scrubber. The Rear Camera 601 feeds the continuous image to the Preprocessing unit 602, which filters and transforms the image to an image of interest. As is known in image processing technology, the continuous image stream may be sampled periodically to provide a series of static images for use in further image processing. The Preprocessing Unit 602 applies image processing filters on the input image to remove noise, reduce size or transform to another space. The two image streams coming from Features Estimation unit 606 and Features Estimation unit 603 are compared in Water Areas Segmentation unit 604. The Water Areas Segmentation Unit 604 examines the generated edge, color and texture features from both rear and front cameras and provides a likelihood for different image areas to be covered with water. A learning-based mechanism such as Support Vector Machine (SVM) can be used. In addition, and not shown, would be a comparison delay equivalent to the transit time for floor scrubber between the two cameras, so that the comparison is on the same area of the floor, pre and post cleaning. The Decision Rendering unit 805, takes the output of the Water Areas Segmentation unit 804 and decides on the presence of water patches and generate appropriate notifications.

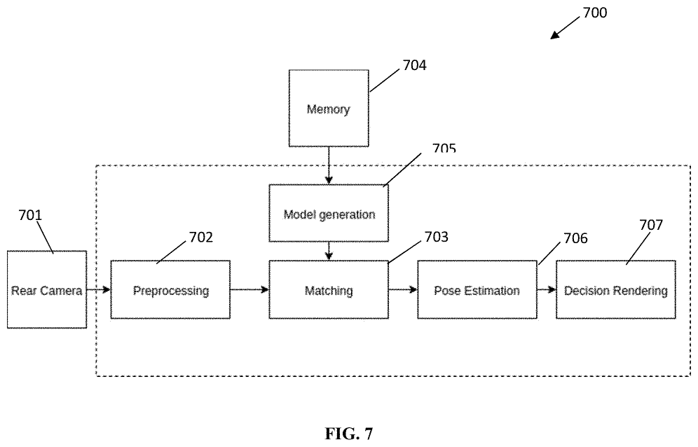

FIG. 7 shows a system block diagram for monitoring one or more consumables. The block diagram 700 of FIG. 7 includes a Rear Camera 701 that sends continuous video output to Preprocessing unit 702. Preprocessing unit 702 provides discrete features extraction and/or applies image processing filters on the input image to remove noise, reduce size or transform to another space. These operations could be done with OpenCV or with similar software libraries. The output of the Preprocessing unit 702 is fed into the Matching unit 703. The Memory 704 contains reference features encoded to facilitate easy comparison the features identified by the Rear Camera 701. The Memory 704 also contains information on where in the visual field the identified objects should be placed. The Memory 704 feeds into the Model Generation unit 705, that creates a model for comparison to the actual features and position observed by the Rear Camera 701. Model generation could be as simple as retrieving a template or a set of features from memory, or it could involve rotating, resizing or subdividing the template or model to match against different possible location and orientations of the squeegee in the image. These operations could be done with the help of standard computer vision or computer graphics libraries such as OpenCV and or OpenGL.

The Matching module 703, compares discrete features by comparing their descriptors which could be done using an algorithm like RANSAC for example which is also available in OpenCV, or by performing patch matching. This can be done with standard techniques available in opensource libraries or coded following well known image processing algorithms. The output of the Matching unit 703 feeds into the Pose Extraction unit 706. Pose estimation uses the results of matching to generate a hypothesis (or hypotheses) about the pose of the squeegee in the image, including a confidence estimation. The Decision Rendering unit 707, utilizes the results of pose estimation to determine whether the squeegee or any of its visually identifiable (visually monitored) mechanical components such as squeegee, squeegee assembly, bolts, carrier, or idler wheels are in the correct position, misaligned, trailing behind the robot or totally absent and generate appropriate notifications and corrective actions. Identifying misplaced or misaligned components is particularly crucial for removeable, replaceable, or disposable parts such as rear squeegee rubbers and idler wheels. While in this implementation, the camera position is advantageously directed to the rear of the device and towards the rear squeegee assembly, other implementations may benefit from cameras other positions, including at the underside, rear, front or side of the floor scrubber.

In another embodiment, the system compares the intensity gradients of a front facing camera with the gradient of a rear facing camera to account for baseline intensity gradients of the surface being cleaned. Some delay or hysteresis is added to the signaling algorithm, for situations where the intensity gradient of the surface being cleaned is changing due to different patterns in the surface.

In some embodiments, the safety systems and/or methods described herein can be executed using any suitable compute device or system including, for example, the same computing facilities as the device application, which may include one or more of the same computer, processor, application-specific integrated circuits (ASICs), field programmable gate array (FPGA), etc. In other embodiments, the safety systems described herein can be executed using a first (e.g., primary) computer, processor, ASIC, FPGA, etc. while receiving input commands from a second (e.g., secondary) computer, processor, ASIC, FPGA, etc. through wireless or non-wireless, analog or digital channels. Any of the safety systems described herein can use a real time operating system or a sensor framework provided by other third party vendors including, but not limited to QNX and VxWorks.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™ Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

While various embodiments have been described above, it should be understood that they have been presented by way of example only, and not limitation. Where schematics and/or embodiments described above indicate certain components arranged in certain orientations or positions, the arrangement of components may be modified. While the embodiments have been particularly shown and described, it will be understood that various changes in form and details may be made.

Although various embodiments have been described as having particular features, concepts, and/or combinations of components, other embodiments are possible having any combination or sub-combination of any features, concepts, and/or components from any of the embodiments described herein. The specific configurations of the various components can also be varied. For example, the specific size, specific shape, and/or specific configuration of the various components and/or various inputs or outputs can be different from the embodiments shown, while still providing the functions as described herein. The size, shape, and/or configuration of the various components can be specifically selected for a desired or intended usage.

Where methods and/or events described above indicate certain events and/or procedures occurring in certain order, the ordering of certain events and/or procedures may be modified and that such modifications are in accordance with accepted and/or desired variations of the specific embodiments. Additionally, certain events and/or procedures may be performed concurrently in a parallel process when possible, as well as performed sequentially as described above. Certain steps may be partially completed or may be omitted before proceeding to subsequent steps.

What is claimed:

1. A computer-implemented method of monitoring a position of a semi-autonomous device for safe navigation in a dynamic, unstructured environment, the method comprising:
detecting localization errors via a check mechanism;
detecting tracking errors to monitor and control device trajectory;
regulating velocity control based on static or dynamic safety zones for collision avoidance;
performing system integrity checks to maintain desired performance over time;
receiving inputs from sensors or safety monitor system that oversees device safety;
monitoring the results of the sensors or safety monitor system; and
if the inputs are above a threshold limit:
providing at least one alert to the device operator and to the system;
providing at least one response to the control of the device navigation system;
wherein the monitoring is done in real-time to execute relevant processes associated with the system independent of other processes performed.

2. The method of claim 1 wherein the alert is selected from a list consisting of a sound, a beep, a vibration, an email, a text message, and a notification on an operator control panel.

3. The method of claim 1 wherein the response is selected from list consisting of stopping the device, sending notifications to the system, recording information into memory, and alerting a safety notification system.

4. The method of claim 1 wherein the check mechanism further comprises an odometry check, a laser map alignment check, or a bimodal distribution check.

5. A computer-implemented method of establishing a location and heading of a semi-autonomous device, the method comprising:
loading a map into memory;
generating at least one speculative location of the device on the map;
calculating a distance to various objects in an environment relative to the device;
discarding less likely locations of the device; and
incrementally moving the device until the differences between measurements to objects in the environment and the measurements to the same objects from one of the locations on the map is within a predetermined error threshold.

6. The method of claim 5 further comprising the step of pruning of bimodal convergence locations.

7. A computer-implemented method of correcting for uncertainty in a location of a semi-autonomous device, the method comprising:
loading a map into memory;
establishing an initial position of the device;
computing an expected position of the device during movement;
measuring the distances to objects in the environment;
comparing these measured distances to expected distances to these same objects on the map;
performing a safe action if differences between the measured distances and the expected distances exceeds a threshold.

8. The method of claim 7 wherein the safe action is selected from a list consisting of stopping the semi-autonomous device, slowing down the semi-autonomous device, alerting an operator of the semi-autonomous device, recording the feature in memory, alerting a remote operator of the semi-autonomous device, and re-planning, repositioning, or re-estimation of localization of the semi-autonomous device.

9. The method of claim 7 wherein the step of computing an expected position is performed by monitoring encoders on moveable wheels.

10. The method of claim 7 wherein the step of measuring the distances to the objects in the environment is performed using an apparatus selected from a list consisting of a camera, infrared camera, laser distance scanner, a sonar ranging systems, radio frequency location markers, proximity detectors, and contact detectors.

11. A computer-implemented method of confirming a correct operation of a semi-autonomous device, the method comprising:
measuring features of the device's environment using at least two measurement mechanisms;
evaluating data from the measurements for patterns indicative of a failed sensor;
evaluating data from each of the measurements for consistency with the device's position; and
performing a safe action if the difference between the measured distances and the expected distances exceeds a threshold.

12. The method of claim 11 wherein the safe action is selected from a list consisting of stopping the semi-autonomous device, slowing down the semi-autonomous device, alerting an operator of the semi-autonomous device, recording the feature in memory, alerting a remote operator of the semi-autonomous device, or re-planning, re-positioning, or re-estimation of localization of the semi-autonomous device.

13. The method of claim 11 wherein the measurement mechanism is selected from a list consisting of an optical camera, a infrared camera, a laser distance measuring system, a sonar scanner, radio frequency location markers, a proximity detector, and a contact detector.

14. A computer-implemented method of controlling a semi-autonomous device, the method comprising:
visually recognizing an object inside a safety zone in close proximity to the device; and
performing a safe action if an object is detected as present.

15. The method of claim 14 wherein the safe action is selected form a list consisting of stopping the semi-autonomous device, shutting down the semi-autonomous device, slowing down the semi-autonomous device, alerting an operator of the semi-autonomous device, recording the condition in memory, and alerting a remote operator of the semi-autonomous device.

16. The method of claim 14 wherein the safety zone dynamically changes size based on at least one of velocity or heading of the semi-autonomous device.

17. The method of claim 14 wherein logic for implementing the safe action is implemented in a Real Time Operating System.

18. The method of claim 14 wherein logic for implementing the safety action is implemented on a separate processing subsystem independent of timing from the non-safety functions of the semi-autonomous device.
